(19) United States
(12) Patent Application Publication
(10) Pub. No.: US 2015/0142535 A1
(43) Pub. Date: May 21, 2015

(54) SAVINGS BEACON AND PARTS ORDER PROCESSING

(71) Applicants: Mark J. Payne, Fort Lauderdale, FL (US); Michael Smith, Lone Tree, CO (US); Bradford Stevens, Lonetree, CA (US)

(72) Inventors: Mark J. Payne, Fort Lauderdale, FL (US); Michael Smith, Lone Tree, CO (US); Bradford Stevens, Lonetree, CA (US)

(21) Appl. No.: 14/523,616

(22) Filed: Oct. 24, 2014

Related U.S. Application Data
(60) Provisional application No. 61/895,910, filed on Oct. 25, 2013.

(51) Int. Cl. G06Q 30/02; G06Q 30/06

(52) U.S. Cl. CPC G06Q 30/0241; G06Q 30/0633
USPC 705/14.4

(57) ABSTRACT

Methods and systems facilitate facilitating notifying a user of potential savings associated with a parts order. According to various implementations, an order file containing order information associated with a first part is received. A determination is made, based on inventory information, that the first part is available from each of a first and second part sellers. Based on a price matrix, a potential cost savings is determined associated with ordering the first part from the first part seller rather than the second part seller, and a savings beacon associated with the part, and indicating the potential savings, is generated and provided to the user.

### CROSS-REFERENCE TO RELATED APPLICATION

This application claims priority to Provisional Application No. 61/895,910, filed on Oct. 25, 2013, the entirety of which is hereby incorporated herein by reference for all purposes.

### BACKGROUND

Conventional dealer management systems (DMSs) provide numerous services for managing automobile dealerships and sometimes include functionality that allows a user (e.g., a dealer, repairman, etc.) to search for, and order, automobile parts. Examples of DMS providers include ADP Dealer Services, Inc.; Dealertrack, Inc.; and The Reynolds and Reynolds Company. To realize savings when ordering parts, the user must often search a number of sellers and compare the prices offered by each, thereby often expending an undesirable amount of time. Similar challenges are experienced in connection with ordering parts in other types of industries, as well.

### SUMMARY

Embodiments of invention disclosed herein include devices, systems, and processes for processing orders, including performing automatic savings determinations and notifications thereof. In this manner, a user may be notified of potential savings, and, in embodiments, may purchase parts at those savings, as part of the ordering process and without requiring the user to manually search for savings by inspecting prices offered by various sellers. Throughout the present disclosure, the term “user” may relate to an individual, a legal entity, a combination of individuals, a combination of legal entities, a representative of an entity, and/or the like. That is, for example, a “user” may be a repair service (e.g., a company), an employee of the repair service (e.g., an individual), a representative of the repair service (e.g., a consultant, attorney, etc.), and/or the like, and may refer to any one or more of the foregoing, interchangeably.

Embodiments of the invention include a system for facilitating notifying a user of potential savings associated with a parts order. The system may include an input/output (I/O) device configured to receive an order file, where the order file includes order information that includes an identification of a first part to be ordered. In embodiments, the I/O device may be configured to receive the order file from a user device, where the user device includes a computing device used by a purchaser of parts associated with at least one of an automobile industry, a watercraft industry, a printer industry, an airplane industry, an appliance industry and/or any other type of entity that orders parts for some type of product and/or service associated with any industry.

In embodiments, the system may include a dealer management system (DMS), where the I/O device is configured to receive the order file from the DMS. The system may also include an application programming interface (API) that facilitates communication between the I/O device and the DMS. Embodiments of the system include a retention device containing inventory information containing information associated with a set of available parts, and a price matrix, the price matrix including an indication of at least one discount to be applied to a base price of the first part, wherein the at least one discount is associated with a first part seller of a plurality of part sellers. The system may further include a savings analysis component configured to determine, based on the inventory information, that the first part is available from each of a first and second part sellers of the plurality of part sellers.

The savings analysis component may further be configured to determine, based on the price matrix, a potential cost savings associated with ordering the first part from the first part seller rather than the second part seller, where the first part is available from the second part seller at the base price, and wherein the first price is lower than the base price, the potential cost savings corresponding to a difference between the first price and the base price. The potential cost savings may correspond, for example, to a difference between the first price and the base price. In embodiments, the second part seller may be an original equipment manufacturer (OEM) of the first part. Additionally, the savings analysis component may be further configured to generate a first savings beacon associated with the first part, the first savings beacon comprising a message that indicates the potential cost savings. In embodiments, the I/O device may be further configured to provide the first savings beacon to the user by providing a message to the user, where the message may include at least one of an email, a short message service (SMS) message, and a toast window.

In embodiments, the first savings beacon includes a selectable link that, when selected by the user, is configured to direct the user to a transaction processing user interface that is configured to enable the user to order the first part. In embodiments, the transaction processing user interface may include an order form configured to enable the user to order a second part, the order form including an input field into which the user may enter an identifier of the second part. Embodiments of the transaction processing user interface may further include a first selectable representation that is configured to facilitate providing a user interface that includes information about parts that the user has ordered; a second selectable representation that is configured to facilitate providing a user interface that includes information about parts that the user is selling; a third selectable representation that is configured to facilitate providing a user interface that includes one or more reports; and/or a fourth selectable representation that is configured to facilitate providing a user interface that includes one or more previous communications directed to the user.

Embodiments of the invention include an illustrative method for facilitating notifying a user of potential savings associated with a parts order. In embodiments, the illustrative method includes receiving an order file, the order file including order information, where the order information includes an identification of a first part to be ordered. Receiving the order file may include, for example, receiving the order file from a user device, where the user device includes a computing device used by a purchaser of parts associated with at least one of an automobile industry, a watercraft industry, a printer industry, an airplane industry, an appliance industry and/or any other type of entity that orders parts for some type of product and/or service associated with any industry. In embodiments, receiving the order file may include receiving the order file from a dealer management system (DMS).

Embodiments of the illustrative method further include determining, based on inventory information stored in a retention device, that the first part is available from each of a first and second part sellers; and determining, based on a price matrix stored in the retention device, a potential cost savings associated with ordering the first part from the first part seller rather than the second part seller. The first part may be available from the second part seller at the base price, and the price matrix may include, for example, an indication of at least one discount to be applied to a base price of the first part, where the at least one discount is associated with the first part seller, and where the first price is lower than the base price, the potential cost savings corresponding to a difference between the first price and the base price. In this case, the potential cost savings may correspond to a difference between the first price and the base price. Embodiments of the illustrative method further include generating a first savings beacon associated with the first part, the first savings beacon including a message that indicates the potential cost savings; and providing the first savings beacon to the user. Providing the first savings beacon to the user may include, for example, providing a message to the user, the message including at least one of an email, a short message service (SMS) message, and a toast window. In embodiments, the second part seller may be an original equipment manufacturer (OEM) of the first part.

In embodiments, the savings beacon may include a selectable link, and the illustrative method may further include receiving an indication that the user has selected the selectable link; and providing, in response to receiving the indication that the user has selected the selectable link, a transaction processing user interface. Embodiments of the method may also include providing an order form configured to enable the user to order a second part. In embodiments, the order form may an input field into which the user may enter an identifier of the second part. Additionally, embodiments of the illustrative method further include providing a first selectable representation that is configured to facilitate providing a user interface that includes information about parts that the user has ordered; providing a second selectable representation that is configured to facilitate providing a user interface that includes information about parts that the user is selling; providing a third selectable representation that is configured to facilitate providing a user interface that includes one or more reports; and/or providing a fourth selectable representation that is configured to facilitate providing a user interface that includes one or more previous communications directed to the user.

Embodiments of the invention further include a system for facilitating notifying a user of potential savings associated with a parts order, the system including a retention device having executable instructions embodied thereon, and a processor configured to execute instructions to instantiate components. In embodiments, the components may include a communication component configured to receive an order file comprising order information, where the order information includes an identification of a first part to be ordered. The communication component may be further configured to receive inventory information that includes information associated with a set of available parts. The components may further include a storage component configured to store the inventory information and a price matrix. In embodiments, the price matrix includes an indication of at least one discount to be applied to a base price of the first part, where the at least one discount is associated with a first part seller of a plurality of part sellers. The components may also include a savings analysis component configured to determine, based on the inventory information, that the first part is available from each of a first and second part sellers of the plurality of part sellers; and determine, based on the price matrix, a potential cost savings associated with ordering the first part from the first part seller rather than the second part seller, where the first part is available from the second part seller at the base price, and where the first price is lower than the base price, the potential cost savings corresponding to a difference between the first price and the base price. The potential cost savings may correspond, for example, to a difference between the first price and the base price. In embodiments, the savings analysis component may also be configured to generate a first savings beacon associated with the first part, the first savings beacon including a message that indicates the potential cost savings, where the communication component is further configured to provide the first savings beacon to the user by providing a message to the user. The message may include, for example, an email, a short message service (SMS) message, and/or a toast window.

In embodiments, the components may further include a transaction component configured to facilitate a transaction in which the user purchases the first part from the first part seller. Additionally, in embodiments, the first savings beacon may include a selectable link that, when selected by the user, is configured to direct the user to a transaction processing user interface that may, in embodiments, be provided by the transaction component. In embodiments, the transaction processing user interface may be configured to enable the user to order the first part, and may include an order form configured to enable the user to order a second part. In embodiments, the second part seller may be an OEM of the first part.

### BRIEF DESCRIPTION OF THE DRAWINGS

FIG. 1 is a schematic diagram illustrating aspects of an operating environment in accordance with embodiments of the invention;

FIG. 2 is a schematic diagram illustrating aspects of an operating environment in accordance with embodiments of the invention;

FIG. 3 is a screenshot illustrating an example of a price matrix in accordance with embodiments of the invention;

FIG. 4 depicts an example of a user interface in accordance with embodiments of the invention;

FIG. 5 depicts an example of a savings beacon email in accordance with embodiments of the invention;

FIG. 6 is a schematic diagram illustrating an example of a method for processing a parts order in accordance with embodiments of the invention; and

FIG. 7 is a flow diagram illustrating an example of a method for processing a parts order in accordance with embodiments of the invention.

While the present invention is amenable to various modifications and alternative forms, specific embodiments have been shown by way of example in the drawings and are described in detail below. The present invention, however, is not limited to the particular embodiments described. On the contrary, the present invention is intended to cover all modifications, equivalents, and alternatives falling within the ambit of the present invention as defined by the appended claims.

Although the term “block” may be used herein to connote different elements illustratively employed, the term should not be interpreted as implying any requirement of, or particular order among or between, various steps disclosed herein unless and except when explicitly referring to the order of individual steps.

### DETAILED DESCRIPTION

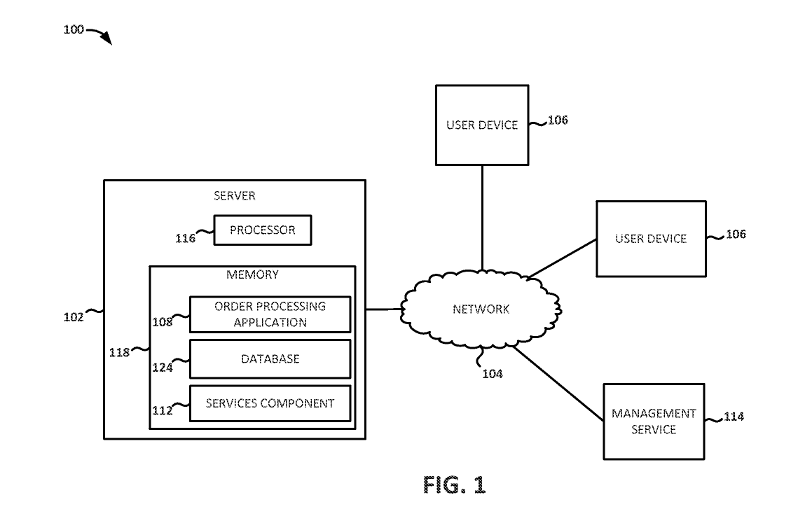

FIG. 1 depicts an example of an operating environment 100 (and, in some embodiments, aspects of the present invention) in accordance with embodiments of the present invention. As shown in FIG. 1, the operating environment 100 includes a server 102 that accesses order information and inventory information, via a network 104, from user devices 106. In embodiments, the server 102 may be maintained, for example, by a savings beacon provider. In embodiments, any number of various aspects of embodiments of the server and its functionality may interact with, be hosted by, and/or be integrated with a dealer management service (DMS) or other service. The network 104 may be, or include, any number of different types of communication networks such as, for example, a short messaging service (SMS), a local area network (LAN), a wireless LAN (WLAN), a virtual private network (VPN), a wide area network (WAN), the Internet, and/or the like.

The user devices 106 may include, for example, computing devices used by a purchaser of parts associated with at least one of an automobile industry, a watercraft industry, a printer industry, an airplane industry, an appliance industry and/or any other type of entity that orders parts for some type of product and/or service associated with any industry. Examples of such users may include an automobile dealer, an automobile manufacturer, an automobile parts manufacturer, an automobile repair service company, a wholesale automobile parts distributor, a retail automobile parts distributer, a watercraft dealer, a watercraft manufacturer, a watercraft parts manufacturer, a watercraft repair service company, a wholesale watercraft parts distributor, a retail watercraft parts distributer, a printer dealer, a printer manufacturer, a printer parts manufacturer, a printer repair service company, a wholesale printer parts distributor, a retail printer parts distributer, an airplane dealer, an airplane manufacturer, an airplane parts manufacturer, an airplane repair service company, a wholesale airplane parts distributor, a retail airplane parts distributer, an appliance dealer, an appliance manufacturer, an appliance parts manufacturer, an appliance repair service company, a wholesale appliance parts distributor, a retail appliance parts distributer and/or any other type of entity that orders parts for some type of product and/or service. According to embodiments, the server 102 implements an order processing application 108 that uses the accessed information to facilitate notifying users of potential savings on parts purchases, processing parts transactions, and the like.

As shown in FIG. 1, the server 102 may be implemented as, and/or on, a computing device that includes a processor 116 and a memory 118. The order processing application 108 may be stored in the memory 118. In embodiments, the processor 116 executes the order processing application 108, which may facilitate analysis of order information to develop savings beacons that can be communicated to users submitting orders. For example, a parts department in a dealership may generate an order file, throughout a business day, that includes identifications of parts to be ordered. Additionally, order files, or portions thereof, may be created automatically by inventory services that determine when parts that are stocked by the dealership should be ordered. This file may be stored, for example, on a storage device maintained by the dealership, on a DMS server located at the dealership, at the DMS provider, and/or the like. In this manner, parts orders can be aggregated before being submitted to the parts seller, which is often a manufacturer (e.g., an OEM). In embodiments, the order processing application 108 facilitates intercepting (e.g., obtaining order information from) this order file before the order is submitted, thereby enabling the order processing application 108 to identify potential savings that the user may be able to realize by purchasing the parts from a seller or sellers other than the manufacturer. These potential savings may be communicated to the user (e.g., via a savings beacon, as explained herein) before the order is submitted, giving the user the opportunity to purchase the parts from, or through, the savings beacon provider.

In embodiments, savings beacons include messages to a user indicating that a part or parts that the user has placed in an order file (that is, e.g., parts that the user is planning to order or has ordered) are available from a certain seller or sellers at a lower price than a base price (e.g., a standard price offered by the manufacturer, an average price offered by the manufacturer, a price offered by another seller or sellers, and/or the like). These messages may include any number of different types of communications provided to users over the network 104 such as, for example, emails, SMS messages, toast (e.g., pop-up) windows, and/or the like. In embodiments, a savings beacon may include a link that, upon selection by the user, directs the user to a user interface hosted by the server 102 that enables the user to order the part or parts from the savings beacon provider or a seller that offers the part or parts at a lower price.

Still referring to FIG. 1, the server 102 obtains, copies, or otherwise accesses order information from one or more user devices 106 and/or a management service 114, which may be or include, for example, one or more dealer management systems (DMSs). Similarly, the server 102 may reference, obtain, copy, or otherwise access inventory information and parts sales information from one or more user devices 106 (e.g., devices used by parts sellers that may be dealers, manufacturers, or the like) and/or a management service 114. According to embodiments, order information, inventory information, and/or sales information may be accessed periodically and/or as the information becomes available. The server 102 may access order information, inventory information, and/or sales information directly, through a third-party service, a DMS (e.g., via an application programming interface (API)), a third party vendor, and/or the like. The server 102 may store the order information, the inventory information, the sales information, or portions thereof in the memory 118 and may, for example, index the information using a database 124. The database 124, which may refer to one or more databases, may be, or include, one or more tables, one or more relational databases, one or more multi-dimensional data cubes, and/or the like. Further, though illustrated as a single component implemented in the memory 118, the database 124 may, in fact, be a plurality of databases 124 such as, for instance, a database cluster, which may be implemented on a single computing device or distributed between a number of computing devices, memory components, and/or the like.

In operation, order processing application 108 accesses order information (e.g., from the memory 118) and, using the order information, generates savings beacons that are provided to users to notify the users of savings potentials associated with certain orders. According to embodiments, the order processing application 108 develops and maintains a dynamic database (e.g., database 124) that includes one or more sets of inventory information, order information, transaction information, and/or pricing information.

In embodiments, inventory information refers to information associated with available parts and may include, for example, inventory identifiers, company identifiers, manufacturer identifiers, franchise identifiers (e.g., identifiers that indicate a particular make of automobile with which a part is compatible), part numbers, prices (e.g., list price, discounted prices, etc.), availability indicators, date indicators (identifying, e.g., a date that a part was added to inventory, etc.), obsolescence indicators (e.g., indicating an age that a part has been available and not sold), and/or the like.

In embodiments, order information refers to information associated with a particular order submitted by a user and may include, for example, an order identifier, a company identifier, a user identifier, a status indicator (indicating the status of the order), date indicators (identifying, e.g., a date that the order was submitted, a date that the order was fulfilled, a date that the database entry was created, etc.), pricing information, savings indicators (e.g., identifying amounts of savings for a part or parts and/or the order), part numbers, quantity identifiers (e.g., identifying a quantity of part ordered, cancelled, filled, etc.), and the like. Historical order information may also be maintained in the database 124 and may include, for example, any number of different types of information associated with completed, pending, and/or cancelled transactions.

In embodiments, transaction information may include, for example, information associated with previous and/or current transactions. That is, for example, transaction information may include details associated with previous completed parts orders, currently pending parts orders, and/or the like and may include, for example, an order identifier, parts numbers, cost information, method of payment, escrow arrangements, shipping orders, sales contracts, and/or the like.

In embodiments, pricing information may include information associated with parts costs, discounts, and/or the like. For example, pricing information may include base prices corresponding to parts, discount prices available from various sellers, historical prices, projected prices, and/or the like. In embodiments, pricing information may include one or more price matrices, as described herein, which may indicate, for one or more sellers, discounts from a base price, available for a part, where the amount of discount from the base price may be determined based on the amount of time that the part has remained, unsold, in inventory. The base price may include a standard price offered to all sellers by an original equipment manufacturer (OEM), an average price offered to sellers by an OEM, a minimum price offered to at least one seller by an OEM, and/or the like.

In embodiments, savings analyses generated by the order processing application may be used to facilitate one or more services. Aspects of the services may be provided using the services component 112 which may include, for example, applications, application programming interfaces (APIs), service functions, and/or the like, that provide savings beacons, ordering services, transaction processing services, reporting services, tracking services, and/or the like. Consumers (e.g., subscribers to services facilitated by aspects of embodiments of the invention described herein) may access the services provided by the services component 112 by communicating with the server 102 using a user device 106.

According to embodiments, various components of the operating environment 100, illustrated in FIG. 1, may be implemented on one or more computing devices. For example, each of the server 102, the user devices 106, and aspects of the management service 114 may be, or reside in, one or more computing devices. A computing device may include any type of computing device suitable for implementing embodiments of the invention. Examples of computing devices include specialized computing devices or general-purpose computing devices such “workstations,” “servers,” “laptops,” “desktops,” “tablet computers,” “hand-held devices,” and the like, all of which are contemplated within the scope of FIG. 1 with reference to various components of the operating environment 100.

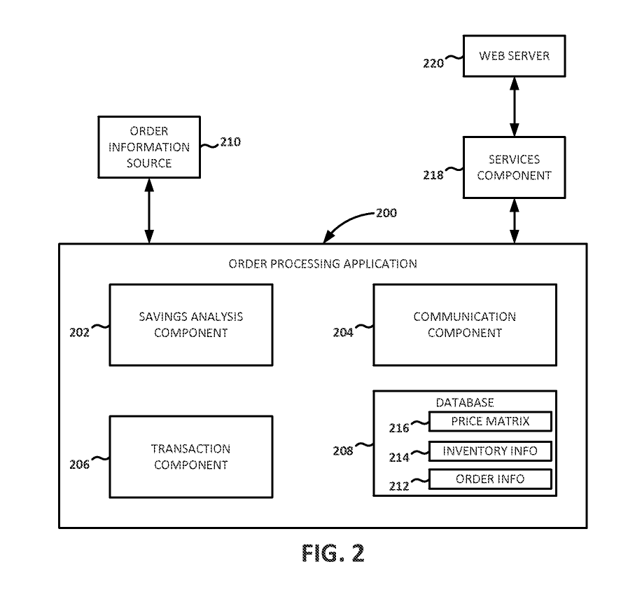

In embodiments, a computing device includes a bus that, directly and/or indirectly, couples the following devices: a processor (e.g., the processor 116 depicted in FIG. 1), a memory (e.g., the memory 118 depicted in FIG. 1, and which may be implemented on a retention device such as a memory component), an input/output (I/O) port, an I/O component (e.g., the communication component 204 depicted in FIG. 2, which may be an I/O device configured to receive communications from a user device 106, for example), and a power supply. Any number of additional components, different components, and/or combinations of components may also be included in the computing device. The bus represents what may be one or more busses (such as, for example, an address bus, data bus, or combination thereof). Similarly, in embodiments, the computing device may include a number of processors, a number of memory components, a number of I/O ports, a number of I/O components, and/or a number of power supplies. Additionally any number of these components, or combinations thereof, may be distributed and/or duplicated across a number of computing devices.

In embodiments, the memory 118 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical and holographic media; magnetic cassettes, magnetic tape, magnetic disk storage and other magnetic storage devices; data transmissions; and any other medium that can be used to store information and can be accessed by a computing device such as, for example, quantum state memory, and the like. In embodiments, the memory 118 stores computer-executable instructions for causing the processor 116 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include the order processing application 108 (and components thereof, illustrated in FIG. 2 and described below), the services component 112, the database 124, and the web server 220 (illustrated in FIG. 2). Program components may be programmed using any number of different programming environments, including various languages, development kits, frameworks, and/or the like. Some or all of the functionality contemplated herein may also be implemented in hardware and/or firmware.

The illustrative operating environment 100 shown in FIG. 1 is not intended to suggest any limitation as to the scope of use or functionality of embodiments of the present invention. Neither should the illustrative operating environment 100 be interpreted as having any dependency or requirement related to any single component or combination of components illustrated therein. Additionally, any one or more of the components depicted in FIG. 1 may be, in embodiments, integrated with various ones of the other components depicted therein (and/or components not illustrated), all of which are considered to be within the ambit of the present disclosure. For example, the services component 112 may be integrated with the order processing application 108.

FIG. 2 depicts an example of a portion of an operating environment (e.g., operation environment 100 depicted in FIG. 1) (and, in some embodiments, aspects of the present invention) having an order processing application 200 (such as, e.g., order processing application 108 depicted in FIG. 1) in accordance with embodiments of the present invention. As shown in FIG. 2, the order processing application 200 includes a savings analysis component 202, a communication component 204, a transaction component 206, and a database 208. As described herein, the savings analysis component 202 may determine potential savings based on available parts corresponding to parts reflected in a set of order information. The communication component 204 may facilitate various communications between the order processing application 200 and users, management systems, and/or the like. The transaction component 206 may facilitate transactions in which users buy parts from other users (e.g., dealers, manufacturers, etc.), or from the savings beacon provider, and may include payment functionality (e.g., automated clearing house (ACH) services, escrow services, financing services, etc.), as well as functionality for facilitating any and/or all aspects of a purchase. In embodiments, for example, a user may purchase parts from the savings beacon provider by submitting a parts order and payment to the savings beacon provider, which directs the order to the particular parts seller for fulfillment. Upon receiving an indication of a commitment, from the seller, to fulfill the parts order, the savings beacon provider may instruct the seller to ship the parts to the user's location. According to embodiments, the savings beacon provider may simply locate a seller for the user, in which case the user may purchase the parts from the seller directly.

The illustrative order processing application 200 shown in FIG. 2 is not intended to suggest any limitation as to the scope of use or functionality of embodiments of the subject matter disclosed herein. Neither should the illustrative order processing application 200 be interpreted as having any dependency or requirement related to any single component or combination of components illustrated therein. For example, in embodiments, the illustrative order processing application 200 can include a subset of the components illustrated therein, additional components, and the like. Additionally, any one or more of the components depicted in FIG. 2 can be, in embodiments, integrated with various ones of the other components depicted therein (and/or components depicted in FIG. 1 and/or not illustrated). Any number of other components or combinations of components can be integrated with the illustrative order processing application 200 depicted in FIG. 2, all of which are considered to be within the ambit of the disclosed subject matter.

According to embodiments, in operation, the savings analysis component 202 receives (e.g., via the communication component 204) order information 212 from an order information source 210 (e.g., one or more user devices 106 and/or management system 114, depicted in FIG. 1) and saves the order information 212 (or portions thereof) in the database 208. The communication component 204 may also receive inventory information 214, pricing information (e.g., information included in a price matrix 216), and/or the like, from parts sellers (e.g., parts dealers, manufacturers (e.g., OEMs), wholesalers, retailers, etc.). This information may also be saved in the database 208. The savings analysis component 202 may reference inventory information 214 to determine whether the ordered parts, and quantities thereof, are available. To the extent that they are available, the savings analysis component 202 may reference a price matrix 216 to determine potential cost savings associated with ordering the parts from various sellers and/or the savings beacon provider. The price matrix 216 may include prices associated with parts from various sellers. In embodiments, a price matrix 216 may be created for each seller.

Generally, manufacturers (e.g., OEMs) may offer one standard price to all purchasers of a particular part. That price is included within the scope of the term “base price” used herein. In some instances, a manufacturer may offer (e.g., based on contract details, market characteristics, etc.) a part to different sellers at different prices. As used herein, the term “base price” may also include each of those different prices, the lowest of those prices, the highest of those prices, an average (e.g., mean, median, mode, etc.) of those prices, or any other price that may be, e.g., calculated based on one or more prices offered by one or more manufacturers of a part. As parts that have been purchased (e.g., from the manufacturer) by a parts seller sit in the seller's inventory, the seller may choose to discount the price of the parts in an attempt to sell them more readily. For instance, when a seller first purchases a part from the manufacturer, and adds it to the seller's inventory, the seller may mark up the price of the part in an attempt to make a profit on its sale. However, as the part remains in inventory over time, the seller may discount the price of the part in an attempt to improve the chances of selling the part.

Because a user (e.g., prospective purchaser) may have an option of purchasing the part from the manufacturer at a base price, embodiments of the invention include a price matrix that indicates potential savings available to the user by purchasing the part from the seller. In embodiments, the potential savings is based on an amount of discount, from the base price, at which the seller is willing to sell the part. In embodiments, price matrices may also reflect amounts of discount available by purchasing the part from one seller as opposed to another seller. Savings beacons, as described herein, may be configured to indicate a maximum potential savings available to the user (e.g., the largest discount available from any of a number of sellers from which the part is available), each amount of potential savings available (e.g., the amount of discount offered by each seller from which the part is available), and/or the like.

In this manner, embodiments of the invention provide an automated incentive to a user to interact with services provided by the savings beacon provider by alerting the user of potential savings that are available to the user (and of which the user may not have been otherwise aware). For example, employees of businesses that order parts (e.g., auto repair service centers, auto dealerships, printer repair services, printer dealerships, watercraft repair service centers, watercraft dealerships, etc.) may utilize software installed on their computers such as, for example, local instantiations of DMS applications, that enable the employees to easily add out-of-stock parts to an order file, which may be transmitted, for example, to an OEM at a certain time, or upon satisfaction of a certain condition (e.g., when a certain number of parts are included in the order file, when the total price associated with an order file has reached a threshold, etc.). Often, users are not encouraged, or incentivized, to search for parts from different sellers that may have the parts available at a discount.

By intercepting the order file before its submission to a seller (e.g., an OEM), the savings beacon provider may automatically provide a savings beacon to the user that alerts the user of potential savings available by ordering the parts from other sellers. The savings beacon may include a selectable link that, when selected by the user, connects the user to a parts ordering service provided by the savings beacon provider that enables the user to order the parts from sellers from which discounts are available without requiring the user to search for the discounted parts (e.g., since the savings beacon provider has already identified those sellers). In this manner, the savings beacon provider may enable the user to maximize profits from parts sales, as well as incentivize the user to use one or more services provided by the savings beacon provider. To facilitate automatically providing effective savings beacons, the savings beacon provider may maintain one or more price matrices, as described herein, that reflect potential savings associated with parts available from one or more sellers.

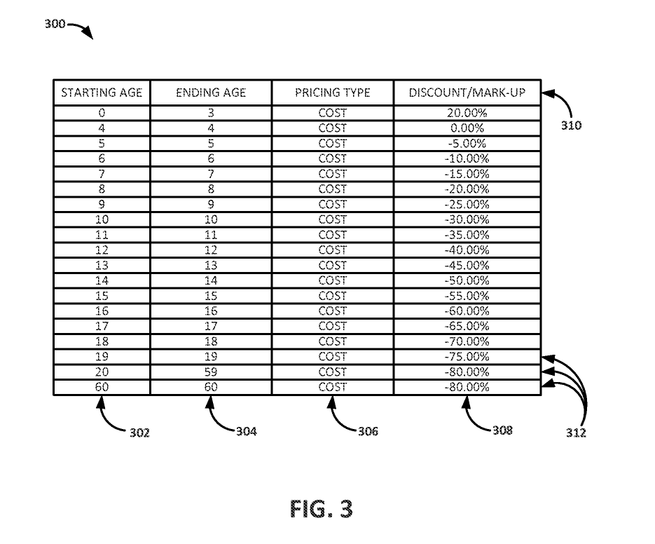

FIG. 3 depicts an illustrative price matrix 300 corresponding to a certain part for a certain seller. The illustrative price matrix 300 may, for example, reflect one or more certain mark-up and/or discount levels to be applied to a particular part (or type of part). The discount levels may, in embodiments, be established based on a part's age (e.g., the length of time the part has been, unsold, in inventory). In embodiments, the price matrix 300 may be provided to the savings beacon provider by the seller and may correspond to one particular part, a particular type or class of parts, all available parts, and/or the like. The illustrative price matrix 300 includes a number of columns 302, 304, 306, and 308, a header row 310 and a number of value rows 312, each value row 312 representing an inventory age range to which a listed discount (or mark-up) 308 applies. Each age range includes a starting age, listed in column 302 and an ending age, listed in column 304. A pricing type for each age range is listed in column 306. In the example, the pricing type is listed as “COST,” meaning that the listed discount is to be applied to a wholesale cost (e.g., a base price) of an individual part. In embodiments, the pricing type may include other values such as, for example, “RETAIL” (in which each listed discount would be applied to pre-determined retail price), “DISCOUNT” (in which each listed discount would be applied to a pre-determined discounted price), and/or the like. The illustrative price matrix 300 depicted in FIG. 3 is just one example of a configuration of a price matrix (e.g., the price matrix 216 depicted in FIG. 2). Other configurations, representing other types of information, may be utilized in various embodiments.

In operation, for example, the savings analysis component 202 may reference pricing information stored in the database 208 to determine a base price for a particular part listed in order information 212 extracted from an order file received, via the communication component 204, from an order information source 210 (e.g., a user, DMS, etc.). The savings analysis component 202 may reference a price matrix 216 (e.g., the price matrix 300 depicted in FIG. 3) corresponding to each seller that has the part available to determine the potential cost savings associated with purchasing the part from each seller. Thus, for example, the savings analysis component 202 may reference inventory information 214 associated with a first seller to determine that the first seller has the part available and that the part has been in inventory for 11 months. By referencing a price matrix associated with the first seller (e.g., the price matrix 300 depicted in FIG. 3), the savings analysis component 202 may determine that the price of a part having an inventory age of 11 months is to be calculated as the base price of the part minus 35 percent of the base price. In embodiments, the savings analysis component 202 may be configured to perform this calculation to determine the potential savings associated with purchasing the part from the first seller. Additionally, if a second seller has the part available, the savings analysis component 202 may perform a similar analysis associated with the second seller and any number of other sellers from which the part is available. In embodiments, the price matrix 300 may include the actual discounted price of the part, in which case the savings analysis component 202 may be configured to simply obtain that discounted price from the price matrix 300.

After determining potential savings associated with various parts identified in the order information 212, the savings analysis component 202 may generate a savings beacon, which is communicated to a user by the communication component 204. In embodiments, the communication component 202 may communicate the savings beacon via email, SMS message, or the like. According to embodiments, the communication component 202 may interact with a services component 218 (e.g., services component 112 depicted in FIG. 1) to communicate the savings beacon to a user via a user interface that is provided by a web server 220. As described above, the savings beacon may indicate a maximum potential savings available for each part, a total potential savings available for the entire order, a break-down of various levels of potential savings available for one or more parts in the order, and/or the like. The savings beacon may also include a selectable link that, when selected by a user, causes the user's device to be navigated to a website provided by the savings beacon provider. In this manner, for example, a user may be presented, via the savings beacon, with an indication of potential savings associated with a parts order, as well as a link that the user can select to be provided with an opportunity to browse various options (e.g., sellers, discounts, etc.) associated with purchasing the parts.

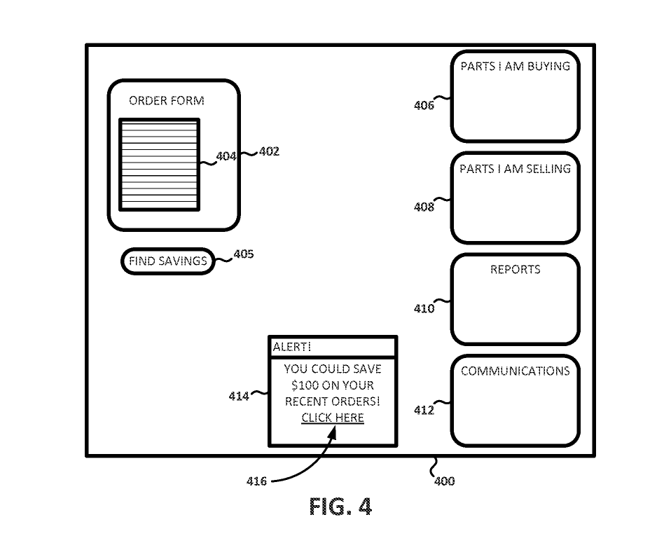

In embodiments, a user may login, via the services component 218, hosted by the web server 220, to a system that includes the order processing application 200 and may be presented with a user interface such as the user interface 400 depicted in FIG. 4. The user may login, for example, subsequent to selecting a selectable link in a savings beacon, subsequent to manually navigating to a website provided by the web server 220, and/or the like. For example, in embodiments, a user may prefer to maintain a user session with the web server 220 so that, as the user or the user's device (e.g., the user device 106 depicted in FIG. 1) populates an order file maintained on the user's device, the savings beacon provider can monitor the entries made to the order file, identify potential savings, and dynamically provide savings beacons 414 (shown in FIG. 4) to the user throughout the day, as the order file is being built. Additionally, the user interface 400 depicted in FIG. 4 may facilitate any number of other services provided by the savings beacon provider.

As shown in FIG. 4, the example user interface 400 includes an order form 402 that a user can utilize to order parts manually. In embodiments, the order form 402 may include one or more input fields 404 into which a user may type or paste part numbers and quantities. This user input may then be processed as a parts order. In embodiments, the user interface 400 may also include a selectable representation 405 that facilitates aspects of embodiments of a process for identifying potential savings, as described herein. The selectable representation 405 may, for example, be provided using an API and may be selectable by a user, whereby selection of the representation 405 results in generation of a listing of sellers from which the parts are available and/or potential savings (prices, price discounts, and/or the like) associated with each. In embodiments, selection of the representation 405 may result in generation of a savings beacon indicating savings available for parts indicated in the order form 402. In this manner, for example, an employee may submit an order for one or more parts and cause a savings beacon to be provided to the employee's manager, a company owner, and/or the like, who may reside at a different location. In embodiments, the selectable representation 405 may be presented on a user interface associated with, for example, a DMS and may be provided by using an API, plug-in, or the like that interacts with the DMS.

The example user interface 400 also includes a set of selectable representations 406, 408, 410, and 412 of various services that may be available to the user. For example, the selectable representation 406 may facilitate providing a user interface that includes information about parts the user has ordered; the selectable representation 408 may facilitate providing a user interface that includes information about parts the user is selling; selectable representation 410 may facilitate providing a user interface that includes reports that may summarize (e.g., using tables, charts, graphs, etc.) any number of various types of information such as, for example, orders, sales, inventory obsolescence, and the like; and selectable representation 412 may facilitate providing a user interface that includes selectable links to communications to and/or from the user such as, for example, savings beacons.

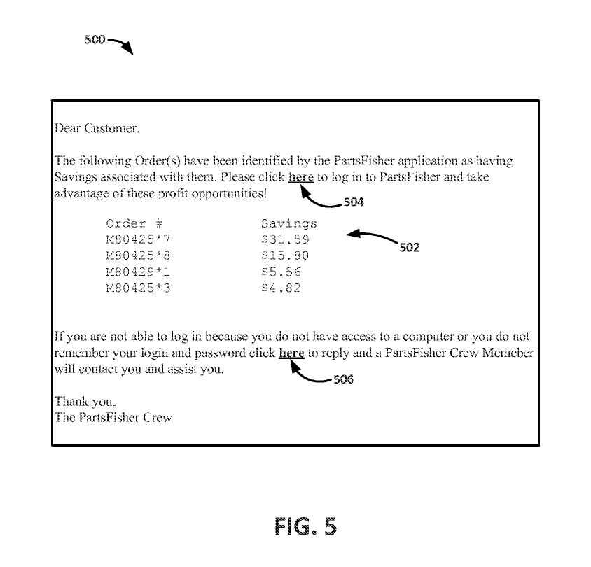

Additionally, as illustrated in FIG. 4, a toast (e.g., pop-up) window 414 may present a savings beacon to the user and may include a selectable link 416 that facilitates providing the user with a user interface through which the user may purchase ordered parts through sellers that offer savings. As mentioned above, a savings beacon may also, or in lieu of the toast window 414, be provided via an email such as, for example, the example savings beacon email 500 depicted in FIG. 5. As shown in FIG. 5, the savings beacon email 500 may include a listing 502 of savings corresponding to various orders. The illustrative savings beacon email 500 depicted in FIG. 5 is just one example of a configuration of a savings beacon email, and other configurations, representing other types of information, may be utilized in various embodiments. For example, the listing 502 of savings may include savings corresponding to particular parts, manufacturers, and/or the like. Additionally, as shown, the email may include a selectable link 504 that, when selected by a user, is configured to direct the user to a transaction processing user interface, the transaction processing user interface configured to enable the user to order one or more parts (e.g., parts associated with the order numbers listed in the list 502 of savings). According to embodiments, clicking on the link 504 in the savings beacon message may additionally, or alternatively, trigger the start of aspects of embodiments of the processes described herein that are performed by the savings analysis component 202. As shown, the savings beacon email 500 may also include a link 506 that can be configured to enable a user to contact the savings beacon provider to receive assistance in using the system.

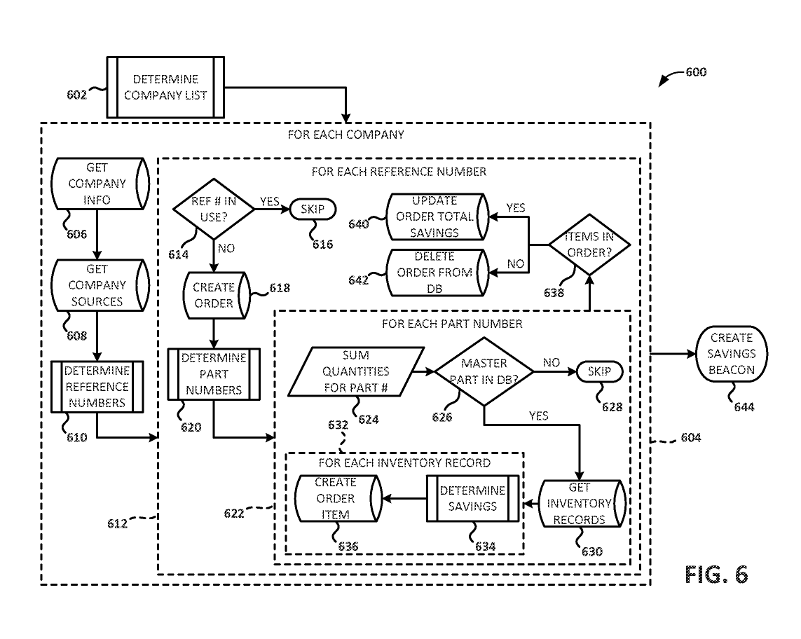

FIG. 6 is a block schematic diagram depicting an illustrative process 600 of notifying a user of potential savings associated with a parts order. In embodiments, for example, one or more aspects of FIG. 6 may be performed by a savings analysis component (e.g., the savings analysis component 202 depicted in FIG. 2) of an order processing application (e.g., order processing application 108 depicted in FIG. 1 and/or 200 depicted in FIG. 2). As shown in FIG. 6, the savings analysis component 202 determines (602) a company list from an order file. The order file may be received from a dealer management service (DMS) and include, for example, a list of companies that have submitted orders.

As shown in FIG. 6, the savings analysis component may perform a first process 604 for each company in the list. In embodiments, the first process may include obtaining (606) company information, obtaining (608) company sources, and determining (610) reference numbers. That is, for example, the savings analysis component may retrieve, from a database maintained on a storage medium, information about the company and a list of parts sources (e.g., parts dealers, parts manufacturers, etc.) from which the company purchases parts. The reference numbers may be included in the order file.

For each reference number, embodiments include a second process 612. The second process may include, for example, determining (614) whether the reference number is currently in use. In embodiments, the savings analysis component may reference a database to determine whether the reference number is currently in use. If the reference number is currently in use, the second process 612 may be skipped (616). If the reference number is not in use, the savings analysis component may create (618) an order corresponding to the reference number. Additionally, as shown in FIG. 6, the savings analysis component determines (620) part numbers from the order file.

For each part number, the savings analysis component may perform a third process 622. As shown in FIG. 6, the third process 622 may include summing (624) (e.g., aggregating) quantities of ordered parts corresponding to the part number, and determining (626) whether a master part exists in the database. For example, the master part may include a record corresponding to the part number and may, in embodiments, be an indication that the part is available from one or more part sellers. If the master part does not exist in the database, the third process 622 may be skipped (628). If the master part does exist in the database, the savings analysis component may retrieve (630) inventory records (e.g., inventory information) associated with the part number. Each inventory record may correspond to a unique part seller. That is, for example, the savings analysis component may retrieve a first inventory record corresponding to the part that is available from a first part seller and a second inventory record corresponding to the part that is available from a second part seller. For each inventory record, the savings analysis component may perform a fourth process 632, which may include determining (634) a potential savings and creating (636) an order item.

As shown in FIG. 6, as part of the second process 612 (for each reference number), the savings analysis component may determine (638) whether there are items in the order, and, if so, update (640) a total potential savings associated with the order. If there are no items in the order (e.g., because none of the parts corresponding to the part numbers in the order file are available from any sellers), the order may be deleted (642) from the database. As is further indicated in FIG. 6, the savings analysis component may create (644) a savings beacon using the total potential savings associated with the order. In embodiments, the savings beacon may itemize the potential savings by part number, inventory record, and/or the like.

The illustrative process 600 shown in FIG. 6 is not intended to suggest any limitation as to the scope of use or functionality of embodiments of the subject matter disclosed herein. Neither should the illustrative process 600 be interpreted as having any dependency or requirement related to any single component or combination of components illustrated therein. For example, in embodiments, the illustrative process 600 can include a subset of the processes illustrated therein, additional processes, and/or the like. Additionally, any one or more of the processes, steps, and/or functionality depicted in FIG. 6 can be, in embodiments, integrated with various ones of the other components depicted therein (and/or features depicted in FIG. 6 and/or not illustrated).

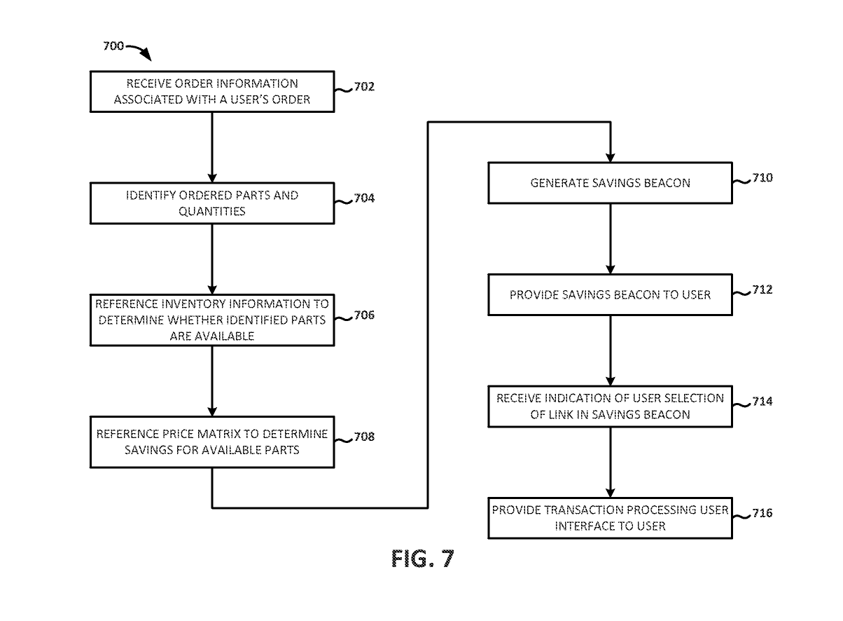

Additional, alternative and overlapping aspects of embodiments of the invention for notifying a user of potential savings associated with an automobile parts order are illustrated in FIG. 7. As described above, an order processing application (e.g., the order processing application 108 depicted in FIG. 1) may receive an order file and use order information contained therein to provide a savings beacon to a user, where the savings beacon indicates potential savings available associated with one or more parts that are to be ordered. FIG. 7 is a flow diagram depicting an illustrative method 700 of processing parts orders in accordance with embodiments of the invention.

Aspects of embodiments of the illustrative method 700 may be performed by, for example, an order processing application (e.g., order processing application 108 depicted in FIG. 1 and/or 200 depicted in FIG. 2). The illustrative method 700 includes receiving order information associated with a user's order (block 702). In embodiments, for example, a communication component (e.g., communication component 204 depicted in FIG. 2) receives an order file that includes the order information. The order file may be received from a user device (e.g., user device 106 depicted in FIG. 1), a management service (e.g., management service 114 depicted in FIG. 1), and/or the like. The user device may include a computing device used by one or more of an automobile dealer, an automobile manufacturer, an automobile parts manufacturer, an automobile repair service company, a wholesale automobile parts distributor, and a retail automobile parts distributer. For instance, an auto repair company or a retail auto part dealer may aggregate, throughout a day or multiple days, a listing of parts that need to be ordered, and may generate an order file that includes the listing. In embodiments, this order file may be provided to, or otherwise retrieved by, a communication component associated with a savings beacon service provider before (or instead of) being sent to a management service.

As shown in FIG. 7, the illustrative method 700 further includes identifying, from the order information, ordered parts and quantities thereof (block 704). For example, the order file may include an identification of a first part to be ordered and a savings analysis component (e.g., savings analysis component 202 depicted in FIG. 2). The method 700 further includes referencing inventory information to determine whether the identified parts (and to what extent the quantities thereof) are available (block 706). For example, the savings analysis component may determine, based on inventory information stored in a retention device (e.g., a storage medium), that the first part is available from each of a first and second part sellers. The savings analysis component may also determine a quantity of the first part that is available from each of the part sellers. In embodiments, the inventory information may be received, by a communication component (e.g., communication component 204 depicted in FIG. 2), from one or more parts sellers, manufacturers, management services, and/or the like. In embodiments, the communication component may periodically receive, and store, inventory information, and, in alternative and/or overlapping embodiments, the communication component may request inventory information in response to the savings analysis component receiving the order information.

As is further depicted in FIG. 7, the illustrative method 700 includes referencing a price matrix to determine potential savings corresponding to available parts (block 708). That is, for example, a savings analysis component may determine, based on a price matrix stored in a retention device, a potential cost savings associated with ordering the first part from the first part seller rather than the second part seller. The price matrix may, for example, include an indication of at least one discount to be applied to a base price of the first part, where the at least one discount is associated with the first part seller, and where the first price is lower than the base price, the potential cost savings corresponding to a difference between the first price and the base price. For example, the base price of the first part may be associated with the second part seller (e.g., an OEM), and the savings analysis component may determine that the first price is lower than the base price, where the potential cost savings corresponds to a difference between the first price and the base price. A savings beacon is generated based on the potential savings (block 710). That is, for example, the savings analysis component may generate a first savings beacon associated with the first part, where the first savings beacon includes a message that indicates the potential cost savings. The potential savings for each part may be communicated to the ordering user via a savings beacon (block 712). In embodiments, providing the first savings beacon to the user may include providing a message to the user, where the message includes at least one of an email, a short message service (SMS) message, and a toast window.

In embodiments, the savings beacon may include a selectable link that, when selected by a user, is configured to direct the user to a transaction processing user interface configured to enable the user to order the first part. As shown in FIG. 7, the order processing application may receive an indication that the user has selected a link provided in the savings beacon (block 714) and, in response, may provide a transaction processing user interface to the user (block 716). In the example referred to throughout the discussion of FIG. 7 above, the order processing application and/or a service associated therewith, may provide an order form configured to enable the user to order a second part. The order form may include an input field into which the user may enter an identifier of the second part.

Embodiments of the illustrative method 700 may also include any number of other steps such as, for example, providing a first selectable representation that is configured to facilitate providing a user interface that includes information about parts that the user has ordered; providing a second selectable representation that is configured to facilitate providing a user interface that includes information about parts that the user is selling; providing a third selectable representation that is configured to facilitate providing a user interface that includes one or more reports; and/or providing a fourth selectable representation that is configured to facilitate providing a user interface that includes one or more previous communications directed to the user. In embodiments, any one or more of the first, second, third, and fourth representations may be provided using an application programming interface (API) on a user interface associated with a dealer management system (DMS).

While embodiments of the present disclosure are described with specificity, the description itself is not intended to limit the scope of this patent. Thus, the inventors have contemplated that the claimed disclosure might also be embodied in other ways, to include different steps or features, or combinations of steps or features similar to the ones described in this document, in conjunction with other technologies. Accordingly, the scope of the present invention is intended to embrace all such alternatives, modifications, and variations as fall within the scope of the claims, together with all equivalents thereof.

The following is claimed:

1. A system for facilitating notifying a user of potential savings associated with a parts order, the system comprising:
an input/output (I/O) device configured to receive an order file, the order file comprising order information, wherein the order information comprises an identification of a first part to be ordered;
a retention device containing (1) inventory information comprising information associated with a set of available parts, and (2) a price matrix, the price matrix comprising an indication of at least one discount to be applied to a base price of the first part, wherein the at least one discount is associated with a first part seller of a plurality of part sellers; and
a savings analysis component configured to:
determine, based on the inventory information, that the first part is available from the first part seller;
determine, based on the price matrix, a potential cost savings associated with ordering the first part from the first part seller rather than a second part seller, wherein the first part is available from the second part seller at the base price, and wherein the first price is lower than the base price, the potential cost savings corresponding to a difference between the first price and the base price; and
generate a first savings beacon associated with the first part, the first savings beacon comprising a message that indicates the potential cost savings, wherein the I/O device is further configured to provide the first savings beacon to the user.

2. The system of claim 1, wherein the second part seller is an original equipment manufacturer (OEM) of the first part.

3. The system of claim 1, wherein the I/O device is configured to receive the order file from a user device, the user device comprising a computing device used by a purchaser of parts associated with at least one of an automobile industry, a watercraft industry, a printer industry, an airplane industry, and an appliance industry.

4. The system of claim 1, further comprising a dealer management system (DMS), wherein the I/O device is configured to receive the order file from the DMS.

5. The system of claim 4, further comprising an application programming interface (API) that facilitates communication between the I/O device and the DMS.

6. The system of claim 1, wherein the I/O device is configured to provide the first savings beacon to the user by providing a message to the user, the message comprising at least one of an email, a short message service (SMS) message, and a toast window.

7. The system of claim 1, wherein the first savings beacon comprises a selectable link that, when selected by the user, is configured to direct the user to a transaction processing user interface, the transaction processing user interface configured to enable the user to order the first part.

8. The system of claim 7, the transaction processing user interface comprising an order form configured to enable the user to order a second part, the order form comprising an input field into which the user may enter an identifier of the second part.

9. The system of claim 8, the transaction processing user interface further comprising:
a first selectable representation that is configured to facilitate providing a user interface that includes information about parts that the user has ordered;
a second selectable representation that is configured to facilitate providing a user interface that includes information about parts that the user is selling;
a third selectable representation that is configured to facilitate providing a user interface that includes one or more reports; and
a fourth selectable representation that is configured to facilitate providing a user interface that includes one or more previous communications directed to the user.

10. A method for facilitating notifying a user of potential savings associated with a parts order, method comprising:
receiving an order file, the order file comprising order information, wherein the order information comprises an identification of a first part to be ordered;
determining, based on inventory information stored in a retention device, that the first part is available from each of a first and second part sellers;
determining, based on a price matrix stored in the retention device, a potential cost savings associated with ordering the first part from the first part seller rather than the second part seller, wherein the first part is available from the second part seller at the base price, and wherein the price matrix includes an indication of at least one discount to be applied to a base price of the first part, wherein the at least one discount is associated with the first part seller, and wherein the first price is lower than the base price, the potential cost savings corresponding to a difference between the first price and the base price;
generating a first savings beacon associated with the first part, the first savings beacon comprising a message that indicates the potential cost savings; and
providing the first savings beacon to the user.

11. The system of claim 10, wherein the second part seller is an original equipment manufacturer (OEM) of the first part.

12. The method of claim 10, wherein receiving the order file comprises receiving the order file from a user device, the user device comprising a computing device used by a purchaser of parts associated with at least one of an automobile industry, a watercraft industry, a printer industry, an airplane industry, and an appliance industry.

13. The method of claim 10, wherein receiving the order file comprises receiving the order file from a dealer management system (DMS).

14. The method of claim 10, wherein providing the first savings beacon to the user comprises providing a message to the user, the message comprising at least one of an email, a short message service (SMS) message, and a toast window.

15. The method of claim 10, wherein the savings beacon comprises a selectable link, the method further comprising:
receiving an indication that the user has selected the selectable link; and
providing, in response to receiving the indication that the user has selected the selectable link, a transaction processing user interface.

16. The method of claim 15, further comprising providing an order form configured to enable the user to order a second part, the order form comprising an input field into which the user may enter an identifier of the second part.

17. The method of claim 16, further comprising:
providing a first selectable representation that is configured to facilitate providing a user interface that includes information about parts that the user has ordered;
providing a second selectable representation that is configured to facilitate providing a user interface that includes information about parts that the user is selling;
providing a third selectable representation that is configured to facilitate providing a user interface that includes one or more reports; and
providing a fourth selectable representation that is configured to facilitate providing a user interface that includes one or more previous communications directed to the user.

18. A system for facilitating notifying a user of potential savings associated with a parts order, the system comprising a retention device having executable instructions embodied thereon, and a processor configured to execute instructions to instantiate components, the components comprising:
a communication component configured to receive (1) an order file comprising order information, wherein the order information comprises an identification of a first part to be ordered, and (2) inventory information comprising information associated with a set of available parts;
a storage component configured to store (1) the inventory information, and (2) a price matrix, the price matrix comprising an indication of at least one discount to be applied to a base price of the first part, wherein the at least one discount is associated with a first part seller of a plurality of part sellers;
a savings analysis component configured to:
determine, based on the inventory information, that the first part is available from the first part seller and a second part seller;
determine, based on the price matrix, a potential cost savings associated with ordering the first part from the first part seller rather than the second part seller, wherein the first part is available from the second part seller at the base price, and wherein the first price is lower than the base price, the potential cost savings corresponding to a difference between the first price and the base price; and
generate a first savings beacon associated with the first part, the first savings beacon comprising a message that indicates the potential cost savings, wherein the communication component is further configured to provide the first savings beacon to the user by providing a message to the user, the message comprising at least one of an email, a short message service (SMS) message, and a toast window; and
a transaction component configured to facilitate a transaction in which the user purchases the first part from the first part seller.

19. The system of claim 18, wherein the first savings beacon comprises a selectable link that, when selected by the user, is configured to direct the user to a transaction processing user interface, the transaction processing user interface configured to enable the user to order the first part.

20. The system of claim 18, wherein the second part seller is an original equipment manufacturer (OEM) of the first part.
